(19) United States
(12) Patent Application Publication
(10) Pub. No.: US 2008/0248366 A1
(43) Pub. Date: Oct. 9, 2008

(54) FUEL CELL WITH A COMBINED FUEL SUPPLY UNIT AND POWER GENERATING UNIT STRUCTURE

(75) Inventors: Che-Ping CHOU, Hsinchu (TW); Chien-Fu Kuo, Hsinchu (TW); Chia-Chieh Shen, Hsinchu (TW); Tsong-Pyng Perng, Hsinchu (TW); Fang-Bor Weng, Hsinchu (TW); Ay Su, Hsinchu (TW); Po-Hsien Chou, Hsinchu (TW); Pai-Ho Hsu, Hsinchu (TW)

Correspondence Address: EGBERT LAW OFFICES, 412 MAIN STREET, 7TH FLOOR, HOUSTON, TX, 77002, US

(73) Assignee: NATIONAL TSING HUA UNIVERSITY, Hsinchu (TW)

(21) Appl. No.: 11/695,878

(22) Filed: Apr. 3, 2007

(51) Int. Cl. H01M 8/04

(52) U.S. Cl. 429/34

(57) ABSTRACT

The present invention is a fuel cell with a combined fuel supply unit and power generating unit. The fuel cell includes a fuel supply unit, a power generating unit, and an enclosure. The fuel supply or fuel storage unit is incorporated laterally or internally into the power generating unit, thereby shortening the fuel pipeline. The performance of the fuel cell is improved, and the space required for fuel cell is reduced for greater applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fuel cell, and more particularly to an innovative fuel cell with a combined fuel storage unit and power generating unit.

2. Description of Related Art Including Information Disclosed Under 37 CFR 1.97 and 37 CFR 1.98

The fuel cell converts chemical energy stored in fuel and air into electric energy. It can generate power continuously if provided externally with fuel and air. Without the limitations of the Carnot cycle, the fuel cell of a modular structure features high energy conversion efficiency and power as a clean and pollution-free unit. It is suitable for centralized power generation and distributed power supply, avoiding energy conversion loss by a thermal generator set (through boilers and steam turbine) and achieving an extremely high power generating efficiency.

In field applications, an integral fuel cell combines a fuel storage unit, a power generating unit and an enclosure. However, most conventional fuel cells are large in size and utilized by large manufacturers. Furthermore, the fuel storage unit is separated from the power generating unit and positioned in a preset compartment, where the fuel is fed to the power generating unit through a channel or pipeline. With continuous development of production technology, the fuel cells will gradually become commonly used products, replacing the existing customized batteries. Thus, there will be a demand for space-saving fuel cells. For this reason, traditional fuel cell structure makes it difficult to reduce the overall space, and the fuel feed pipeline will also lead to poorer supply efficiency and greater loss in overall performance.

Thus, to overcome the aforementioned problems of the prior art, it would be an advancement in the art to provide an improved structure that can significantly improve efficiency.

To this end, the inventor has provided the present invention of practicability after deliberate design and evaluation based on years of experience in the production, development and design of related products.

### BRIEF SUMMARY OF THE INVENTION

The fuel storage unit 10 of the present invention is incorporated laterally or internally into the power generating unit 20 to shorten the flow channel from the fuel storage unit 10. The present invention shortens the fuel pipeline compared with fuel cell of the prior art. Moreover, fuel (e.g. hydrogen) is supplied to power generating unit 20 more steadily and efficiently, thus improving the operating performance of the fuel cell.

Since the fuel storage unit 10 is incorporated into the power generating unit 20, it is possible to significantly reduce the volume of the fuel cell so as to cater to space-saving demands for the benefit of the general public.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a longitudinal cross-sectional view of the preferred embodiment of the present invention.

FIG. 2 shows a radial cross-sectional view of the preferred embodiment of the present invention.

FIG. 3 shows a top plan view of another preferred embodiment of the present invention.

FIG. 4 shows another plan view of a second embodiment of the power generating unit of the present invention.

FIG. 5 shows a plan view of a third embodiment of the power generating unit of the present invention.

FIG. 6 shows a plan view of a fourth embodiment of the power generating unit of the present invention.

FIG. 7 shows another plan view of a fifth embodiment of the power generating unit of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

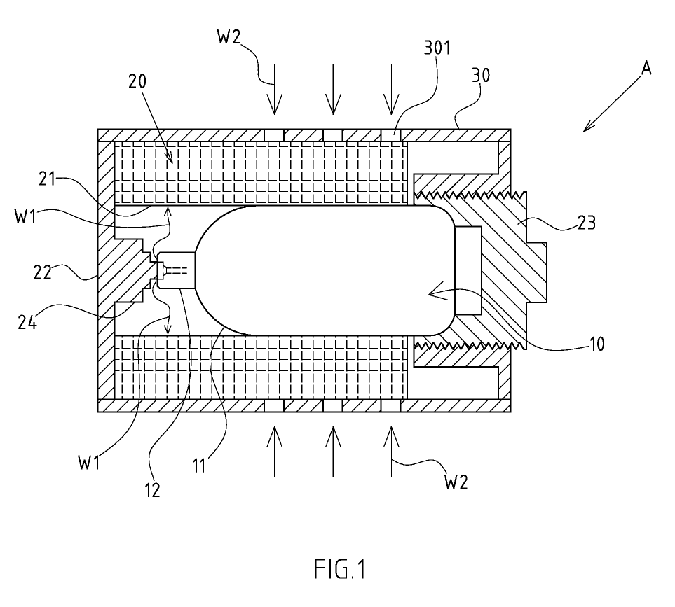

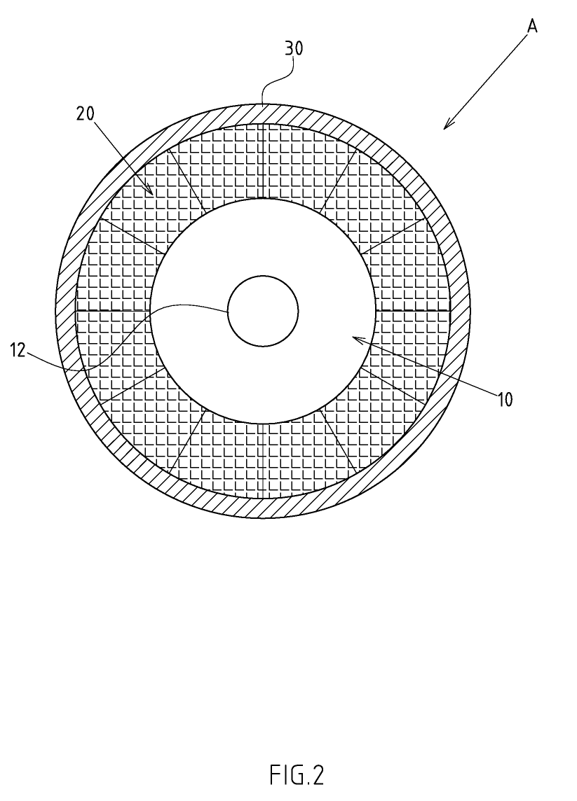

FIGS. 1 and 2 depict a preferred embodiment of the improved fuel cell structure of the present invention. The preferred embodiment is presented for explanatory purposes. The scope of the patent is set by the patent claims.

The fuel cell A comprises a fuel storage unit 10, a power generating unit 20 and an enclosure 30. The fuel storage unit 10 and power generating unit 20 are installed in the enclosure 30. The fuel storage unit 10 may be a hydrogen tank, which is composed of a housing 11 and a fuel discharge portion 12. The enclosure 30 is a cylindrical body fitted with an air inlet 301. The technical feature of the present invention is that the fuel storage unit 10 is incorporated laterally or internally into the power generating unit 20, thereby considerably shortening the flow channel between the fuel storage unit 10 and the power generating unit 20.

FIGS. 1 and 2 depict a preferred embodiment of fuel storage unit 10 incorporated into the power generating unit 20. The power generating unit 20 is formed by a cylindrical structure, at the center of which a through-hole space 21 is positioned to accommodate the fuel storage unit 10. Furthermore, a spacing cover 22 and a fastening seat 23 are installed at both ends of the space 21. The fuel discharge portion 12 of the fuel storage unit 10 adapts to the projecting portion 24 within the spacing cover 22, while the other end of the fuel storage unit 10 is locked onto the fastening seat 23. Referring to FIG. 1, when the fuel storage unit 10 is locked, the fuel discharge portion 12 compresses to discharge hydrogen (W1). The hydrogen (W1) will then flow into the power generating unit 20. On the other hand, oxygen (W2) in the external environment flows into power generating unit 20 via air inlet 301 of the enclosure 30. The hydrogen (W1) and oxygen (W2) are then guided to power generating unit 20 and converted into electric energy via an electrochemical reaction.

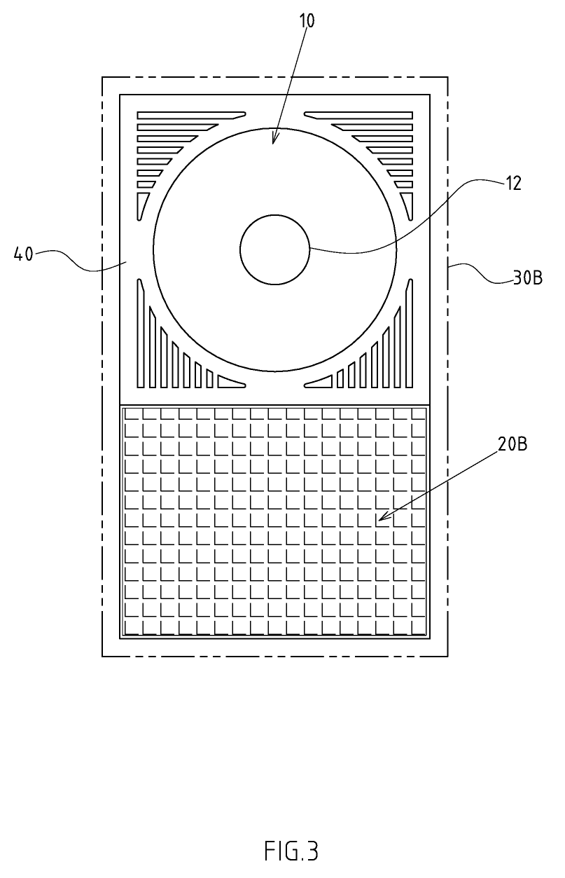

FIG. 3 depicts another preferred embodiment of fuel storage unit 10 incorporated into the power generating unit 20. The power generating unit 20B of the present invention is placed laterally onto the fuel storage unit 10, and the enclosure 30B is a rectangular body. If the fuel storage unit 10 is a hydrogen tank, it is generally formed by an unsteady steel cylinder, so a square framework 40 can be provided for stable positioning.

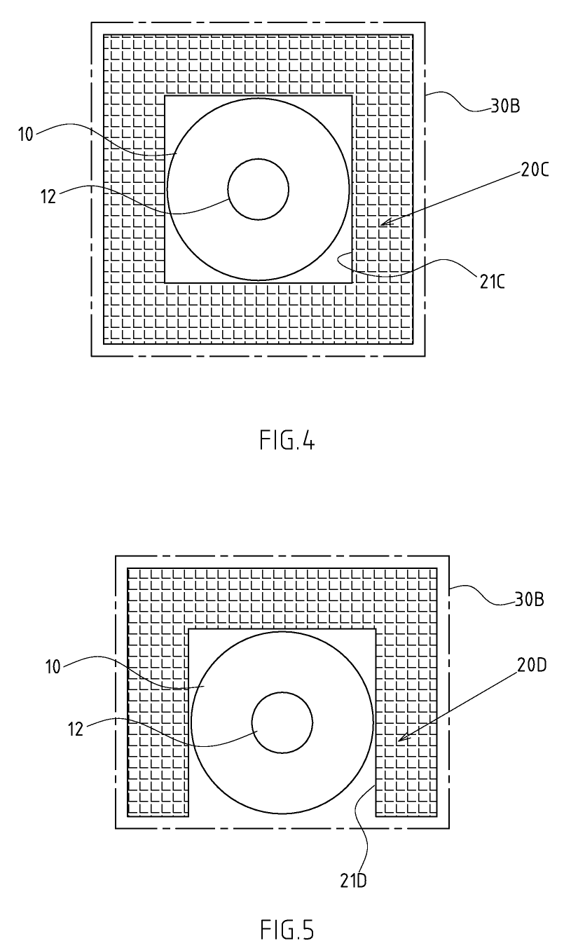

Referring to FIG. 4, the power generating unit 20C is formed by a rectangular cylinder, at the center of which a mouth-shaped space 21C is shaped to accommodate the fuel storage unit 10.

Referring to FIG. 5, the power generating unit 20D is formed by a [symbol] -shaped structure, such that a recessed space 21D is shaped to accommodate the fuel storage unit 10.

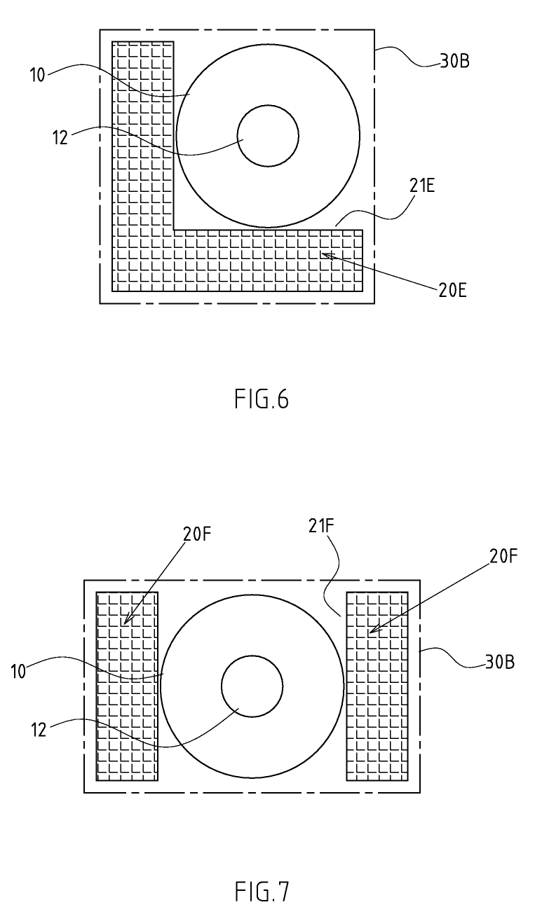

Referring to FIG. 6, the power generating unit 20E is formed by an L-shaped structure, such that a recessed space 21E is shaped to accommodate the fuel storage unit 10.

Referring to FIG. 7, the power generating unit 20F is formed by a two-body structure, such that a recessed space 21F is shaped to accommodate the fuel storage unit 10.

We claim:

1. A combined fuel cell structure, comprising:
a power generating unit;
a fuel supply unit, being incorporated laterally or internally into said power generating unit; and
an enclosure, housing said fuel supply unit and said power generating unit.

2. The fuel cell structure defined in claim 1, wherein said fuel supply unit is comprised of a hydrogen tank.

3. The fuel cell structure defined in claim 1, wherein said power generating unit is comprised of a circular or rectangular cylinder, having a through-hole at a center thereof and being shaped to accommodate said fuel storage unit.

4. The fuel cell structure defined in claim 1, wherein said power generating unit is comprised of a [symbol] -shaped structure having a recessed space, said recessed shape accommodating said fuel supply unit.

5. The fuel cell structure defined in claim 1, wherein said power generating unit is comprised of an L-shaped structure having a recessed space, said recessed shape accommodating said fuel supply unit.

6. The fuel cell structure defined in claim 1, wherein said power generating unit is comprised of a two-body structure having a recessed space, said recessed space accommodating said fuel supply unit.
